(19) United States
(12) Patent Application Publication
(10) Pub. No.: US 2017/0008231 A1
(43) Pub. Date: Jan. 12, 2017

(54) METHOD OF MANUFACTURING LAYERED OBJECT, DEVICE OF MANUFACTURING LAYERED OBJECT, AND SLURRY

(71) Applicant: KABUSHIKI KAISHA TOSHIBA, Tokyo (JP)

(72) Inventors: Hideaki HIRABAYASHI, Yokohama (JP); Kuniaki YAMAMOTO, Yokohama (JP); Haruhiko ISHIHARA, Yokohama (JP); Kenichi OOSHIRO, Yokohama (JP)

(73) Assignee: KABUSHIKI KAISHA TOSHIBA, Minato-ku, Tokyo (JP)

(21) Appl. No.: 15/023,282

(22) PCT Filed: Feb. 17, 2015
(86) PCT No.: PCT/JP2015/054297

§ 371 Date: Mar. 18, 2016

(30) Foreign Application Priority Data
Mar. 31, 2014 (JP) 2014-074096

(51) Int. Cl. B29C 67/00; C09D 7/00

(52) U.S. Cl. CPC B29C 67/0066; C09D 7/001; B33Y 10/00

(57) ABSTRACT

A method of manufacturing a layered object includes: a first process of supplying, onto a stage, a first slurry layer that includes a powder having a volume concentration of not smaller than 10% and not larger than 15% and a solvent; a second process of irradiating a part of the first slurry layer with an energy beam to form a part of the layered object; a third process of supplying a second slurry layer onto the part of the layered object; and a fourth process of irradiating a part of the second slurry layer with an energy beam to form another part of the layered object. The third process and the fourth process are repeated more than once.

### FIELD

Embodiments of the present invention relate to a method of manufacturing a layered object, a device of manufacturing the layered object, and slurry.

### BACKGROUND

For example, there is a method of manufacturing a layered object that supplies a raw material and simultaneously melts the raw material by heating with laser so as to form a shaped object having a desired shape. Such a manufacturing method is desired to have an improved productivity.

### CITATION LIST

### Patent Literature

Patent Literature 1: Japanese Laid-open Patent Publication No. 2006-200030

### SUMMARY OF THE INVENTION

### Problem to be Solved by the Invention

Embodiments of the present invention provide a highly productive method of manufacturing a layered object, a device of manufacturing the layered object, and slurry.

### Means for Solving Problem

According to embodiments of the present invention, a method of manufacturing a layered object is provided. The method includes: a first process of supplying a layer of first slurry that includes powder onto a stage; a second process of irradiating a part of the layer of the first slurry with an energy beam to form a part of the layered object; a third process of supplying a layer of second slurry onto the part of the layered object; and a fourth process of irradiating part of the layer of the second slurry with an energy beam to form another part of the layered object. The third process and the fourth process are repeated more than once.

### BRIEF DESCRIPTION OF DRAWINGS

FIG. 1 is a schematic sectional view illustrating a method of manufacturing a layered object according to a first embodiment.

FIG. 2 is a schematic sectional view illustrating a method of manufacturing a layered object according to a second embodiment.

FIG. 3 is a schematic sectional view illustrating a method of manufacturing a slurry film.

FIG. 4 is a schematic sectional view illustrating a method of manufacturing a layered object according to a third embodiment.

FIG. 5 is a schematic perspective view of a device used in an experiment.

FIGS. 6(a) to 6(d) are each a pattern diagram illustrating a property of slurry.

### DETAILED DESCRIPTION

Embodiments of the present invention will be described below with reference to the accompanying drawings.

The drawings are schematic or conceptual. The relationship between the thickness and width of each part and the dimensional proportion of parts, for example, are not necessarily identical to those in reality. The same part may be illustrated in different sizes and proportions between drawings.

In the specification and drawings of the present application, the same elements as those already described with reference to a drawing are denoted with identical reference symbols, and a detailed description thereof is omitted as appropriate.

### First Embodiment

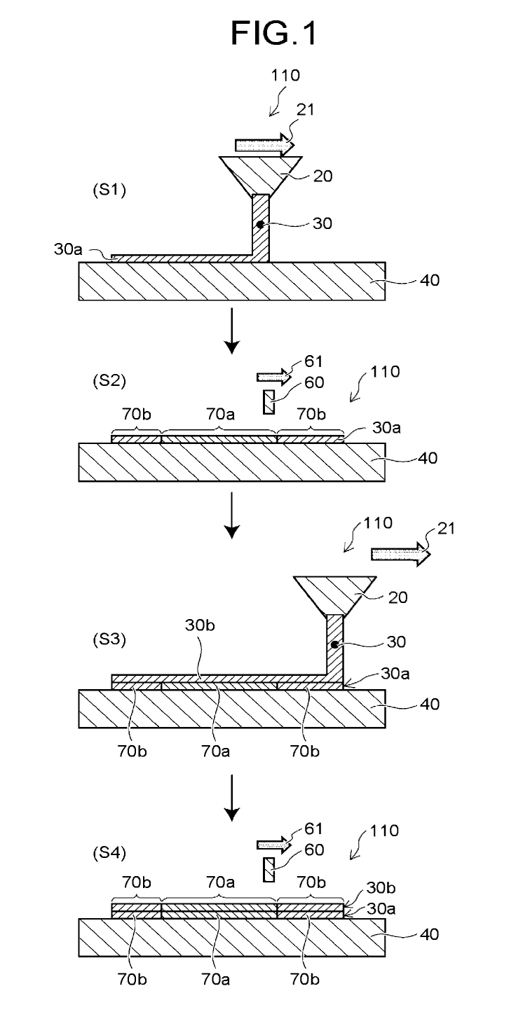

FIG. 1 is a schematic sectional view illustrating a method of manufacturing a layered object according to a first embodiment. In a manufacturing device 110 according to the present embodiment, a layer supplying unit 20, a stage 40, a squeegee 50, and an energy beam irradiation unit 60 are provided. The layer supplying unit 20 supplies a layer 30a of slurry 30 including powder (hereinafter referred to as a slurry layer 30a) onto the stage 40. In this example, the layer supplying unit 20 applies the slurry 30 onto the stage 40 to form the slurry layer 30a. Various kinds of methods are applicable as this application method. For example, a dispenser method, an inkjet method, a slit coating method, or a spin coating method may be selected as the application method.

In the embodiments, slurry is a muddy fluid in which powder as a material of a layered object is suspended in liquid. The powder is, for example, a metal such as steel and stainless steel. The powder may be ceramic. The powder may be a mixture of metal and ceramic. The powder has an average particle size of, for example, equal to or larger than 1 μm and equal to or smaller than 100 μm, more preferably, equal to or larger than 10 μm and equal to or smaller than 50 μm.

The slurry 30 may include a solvent. The solvent is any of, for example, alcohols such as ethanol and methanol, various kinds of ethers, and ketones. In other words, the slurry 30 may include: the powder as a material of the layered object; and a solvent including at least one selected from the group consisting of alcohols, ethers, and ketones.

The slurry 30 preferably has a viscosity of, for example, equal to or larger than 1 and equal to or smaller than 200 cp for the inkjet method. For the slit coating method, the viscosity is preferably equal to or larger than 1 and equal to or smaller than 50,000 cp. For the spin coating method, the viscosity is preferably equal to or larger than 1 and equal to or smaller than 300 cp.

The slurry 30 preferably further includes at least one of a thickening agent, a reducing agent, and a rust preventive agent. When the thickening agent is included, for example, the amount of cracks caused when the slurry layer 30a is dried fast can be reduced. The reducing agent is, for example, formalin or dimethylamine borane. When the reducing agent is included, sinterability of the powder can be improved. The rust preventive agent is, for example, benzotriazole. When the rust preventive agent is included, for example, oxidation of the surface of the powder can be reduced.

The energy beam irradiation unit 60 irradiates a part of the slurry layer 30a with an energy beam in accordance with the shape of the layered object, and forms a part of the layered object from the slurry layer 30a irradiated with the energy beam. The energy beam is, for example, laser light (carbon dioxide laser or YAG laser, for example). By heating with the energy beam, the powder included in the slurry layer 30a is heated and sintered. The energy beam irradiation unit 60 may melt the powder included in the slurry layer 30a and solidify the powder. In this manner, the part of the layered object is formed.

In the present embodiment, laser light is used as the energy beam. Any energy beam that can melt the material as the laser light does is applicable. The energy beam may be, for example, an electron beam, microwaves, or electromagnetic waves in the ultraviolet range.

In FIG. 1, the layer supplying unit 20 is moved relative to the stage 40 in the direction of an arrow 21 so as to supply the slurry layer 30a (a first slurry layer) onto the stage 40 (step S1; corresponding to a first process). The moving direction of the layer supplying unit 20 is not limited to this direction. In this example, the slurry layer 30a is supplied by applying the slurry 30 onto the stage 40. This application may employ a method selected from, for example, the dispenser method, the inkjet method, the slit coating method, and the spin coating method, as described above.

A part of the slurry layer 30a on the stage 40 is irradiated with an energy beam (for example, laser light) while the energy beam irradiation unit 60 is scanning in the direction of an arrow 61. The moving direction of the energy beam irradiation unit 60 is not limited to the direction of the arrow 61. Accordingly, a sintered part 70a and a non-sintered part 70b are formed in the slurry layer 30a (step S2; corresponding to a second process). In this manner, a part of the layered object is formed from the slurry layer 30a irradiated with the energy beam.

The layer supplying unit 20 is moved relative to the stage 40 in the direction of the arrow 21. The layer supplying unit 20 supplies (applies) another slurry layer 30b of the slurry 30 (a second slurry layer) on the part of the layered object (the slurry layer 30a) (step S3; corresponding to a third process).

A part of the other slurry layer 30b is irradiated with an energy beam (for example, laser light) while the energy beam irradiation unit 60 is scanning in the direction of the arrow 61. Accordingly, the sintered part 70a and the non-sintered part 70b are formed in the other slurry layer 30b (step S4; corresponding to a fourth process). In this manner, another part of the layered object is formed from the other slurry layer 30b irradiated with the energy beam.

Steps S3 and S4 are repeated more than once to form a desired layered object.

There may be a reference example which does not use slurry. In this reference example, powder such as metal and ceramic is supplied onto a stage, and squeegeeing (planarization) is performed on this powder using a jig called a squeegee. In order to achieve a high density and high strength of the layered object, in particular, powder having a small particle size (equal to or smaller than 20 μm, for example) is used in some cases. In such a case, the powder having a small particle size may adhere to the squeegee, so that inadequate squeegeeing may be caused.

In contrast, in the present embodiment slurry including powder as a material is used for shaping. This can prevent inadequate squeegeeing especially when the powder which has a small particle size is used. Accordingly, a higher productivity can be achieved. The powder having a small particle size can be used, which allows a manufactured layered object to have a higher density and an improved strength, for example.

### Second Embodiment

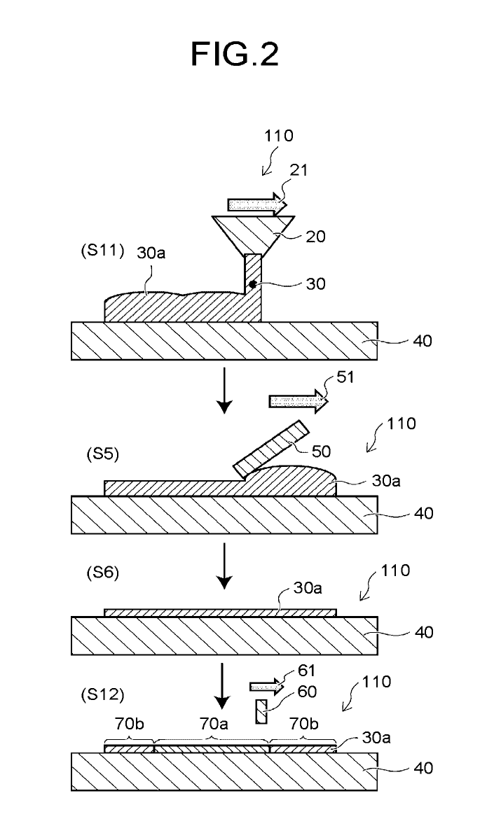

FIG. 2 is a schematic sectional view illustrating a method of manufacturing a layered object according to a second embodiment.

In FIG. 2, the layer supplying unit 20 is moved relative to the stage 40 in the direction of the arrow 21 so as to supply the slurry layer 30a onto the stage 40 step S11; corresponding to the first process). In this example, similarly to the first embodiment, the slurry layer 30a is supplied by applying the slurry 30 onto the stage 40. This application can employ a method selected from the dispenser method, the inkjet method, the slit coating method, and the spin coating method, for example, as described above.

The squeegee 50 is moved relative to the slurry layer 30a on the stage 40 in the direction of an arrow 51 so as to planarize the surface of the slurry layer 30a (step S5; corresponding to a fifth process). Step S5 is performed as necessary. Step S5 may be omitted, for example, when the layer obtained through the process at step S11 is relatively flat.

The slurry layer 30a on the stage 40 is dried under a predetermined drying condition so as to remove the solvent included in the slurry layer 30a (step S6; corresponding to a sixth process). When the slurry layer 30a includes a thickening agent, this thickening agent may be thermally decomposed at a high temperature through this drying process. The thickening agent may be incinerated by ashing after the drying. At least a part of the surface of the powder may be reduced by ashing in hydrogen gas atmosphere. Fast drying may generate a crack in the slurry layer 30a in some cases. This crack generation can be reduced by, for example, slow drying in solvent atmosphere. At least one of temperature and humidity may be controlled. Step S6 is performed as necessary. Step S6 may be omitted, for example, when the slurry layer 30a is sufficiently dry.

A part of the slurry layer 30a on the stage 40 is irradiated with an energy beam (for example, laser light) while the energy beam irradiation unit 60 is scanning in the direction of the arrow 61. Accordingly, the sintered part 70a and the non-sintered part 70b are formed in the slurry layer 30a (step S12; corresponding to the second process). In this manner, a part of the layered object is formed from the slurry layer 30a irradiated with the energy beam.

In the present embodiment, steps S5 and S6 may be performed as necessary.

Step S5 may be performed between steps S3 and S4 described in the first embodiment (FIG. 1). At step S5, the surface of the other slurry layer 30b, which is supplied on the part of the layered object (the slurry layer 30a), is planarized. Similarly, step S6 may be performed between steps S3 and S4 described in the first embodiment. At step S6, a part of the other slurry layer 30b with an energy beam is irradiated so as to form another part of the layered object.

In the above description, for example, steps S3, S5, S6, and S4 may be repeatedly performed. For example, steps S3, S5, and S4 may be repeatedly performed. For example, steps S3, S6, and S4 may be repeatedly performed. At least one of steps S5 and S6 may be selectively performed at any process in a plurality of repetitions.

As described above, when the squeegeeing (planarization) is performed using the jig called a squeegee, powder having a small particle size (equal to or smaller than 20 μm, for example) may be used in some cases to achieve a high density and high strength of the layered object, in particular. In such a case, the powder having a small particle size may adhere to the squeegee, so that inadequate squeegeeing may be caused.

In contrast, in the present embodiment, slurry including powder as a material is used for shaping. This can prevent inadequate squeegeeing especially when the powder which has a small particle size is used. Accordingly, a higher productivity can be achieved. The powder having a small particle size can be used, which allows a manufactured layered object to have a higher density and an improved strength, for example. This allows highly precise manufacturing of the layered object.

### Third Embodiment

In the present embodiment, a film of slurry (hereinafter referred to as a slurry film) is manufactured in advance and disposed on a stage to be irradiated with an energy beam.

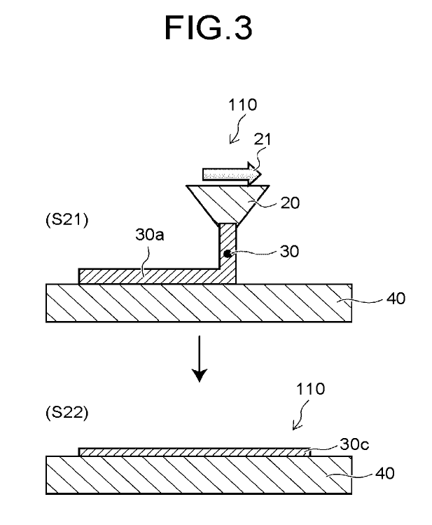

FIG. 3 is a schematic sectional view illustrating a method of manufacturing a slurry film.

The slurry film can be manufactured by, for example, the method of forming the slurry layer 30a described in the first embodiment. For example, the layer supplying unit 20 is moved relative to the stage 40 in the direction of the arrow 21 so as to supply a slurry film 30c onto the stage 40 (step S21). For example, the slurry film 30c is supplied by applying the slurry 30 onto the stage 40. This application can employ a method selected from the dispenser method, the inkjet method, the slit coating method, and the spin coating method, for example.

The surface of the slurry film 30c on the stage 40 is planarized as necessary. The slurry film 30c on the stage 40 is dried under a predetermined drying condition so as to remove the solvent included in the slurry film 30c (step S22). Steps S21 and S22 are repeated more than once, so that a plurality of slurry films are manufactured. The manufactured slurry films may be put into rolls. Step S22 is performed as necessary and appropriate.

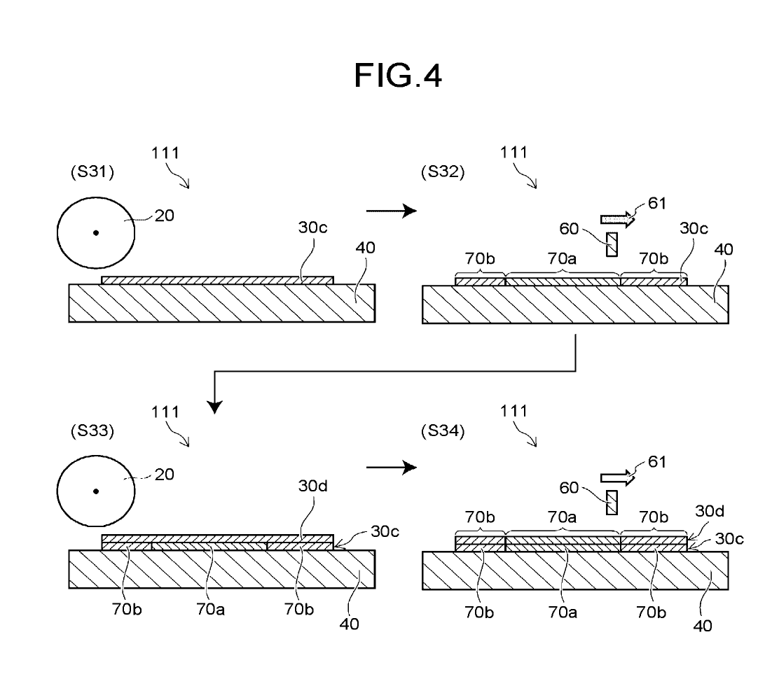

FIG. 4 is a schematic sectional view illustrating a method of manufacturing a layered object according to a third embodiment. In a manufacturing device 111 according to the present embodiment, the layer supplying unit 20, the stage 40, and the energy beam irradiation unit 60 are provided. The manufactured slurry film 30c (a first slurry film) is arranged on the stage 40 by the layer supplying unit 20 (step S31; corresponding to the first process). The layer supplying unit 20 such as a roller transferring films is provided. The layer supplying unit 20 may be, for example, a robotic arm.

Then, a part of the slurry film 30c on the stage 40 is irradiated with an energy beam (for example, laser light) while the energy beam irradiation unit 60 is scanning in the direction of the arrow 61. Accordingly, the sintered part 70a and the non-sintered part 70b are formed in the slurry film 30c (step S32; corresponding to the second process). In this manner, a part of the layered object is formed from the slurry film 30c irradiated with the energy beam.

The layer supplying unit 20 disposes another slurry film 30d (a second slurry film) on the part of the layered object (the slurry film 30c) (step S33; corresponding to the third process). A part of the other slurry film 30d is irradiated with an energy beam while the energy beam irradiation unit 60 is scanning in the direction of the arrow 61. Accordingly, the sintered part 70a and the non-sintered part 70b are formed in the other slurry film 30d (step S34; corresponding to the fourth process). In this manner, another part of the layered object is formed from the slurry film 30d irradiated with the energy beam.

The above-described steps S33 and S34 are repeated more than once to form a desired layered object.

According to the present embodiment, inadequate squeegeeing is not caused. In addition, by manufacturing slurry films in advance, productivity is improved. Specifically, the process of disposing a slurry film onto a stage and the process of irradiating a part of the disposed slurry film with an energy beam are repeated. Thus, a simplified process is achieved. Accordingly, a desired layered object can be efficiently obtained. Moreover, the layered object can be highly precisely manufactured.

### Fourth Embodiment

The present embodiment relates to a manufacturing device for a layered object.

As illustrated in FIG. 1, the manufacturing device 110 according to the present embodiment includes the layer supplying unit 20, the stage 40, and the energy beam irradiation unit 60. The squeegee 50 may be provided as necessary.

The layer supplying unit 20 supplies a layer of slurry including powder as a material for shaping layers onto the stage 40. The layer supplying unit 20 is, for example, a head used in the dispenser method, the inkjet method, or the slit coating method described with reference to FIG. 1. Alternatively, the layer supplying unit 20 may be a spinner used in the spin coating method. The layer supplying unit 20 may be a roller or a robotic arm as in the manufacturing device 111 illustrated in FIG. 4.

The energy beam irradiation unit 60 irradiates a part of a layer supplied on the stage 40 with an energy beam so as to form a part of a layered object from the layer irradiated with the energy beam. Each of a plurality of layers included in the layered object is formed by supplying a slurry layer or a slurry film and simultaneously solidifying the slurry layer or the slurry film through sintering or melting by heating with the energy beam (for example, laser light). These processes are repeated more than once, so that a desired layered object is formed.

The following describes an illustrative result of an experiment on the planarity of a layer of powder and a layer of slurry.

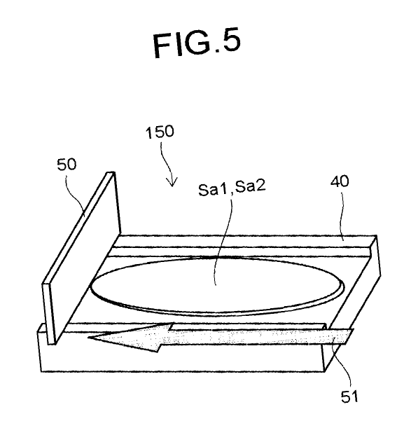

FIG. 5 is a schematic perspective view of a device used in the experiment.

In this device 150, the stage 40 and the squeegee 50 are provided. The squeegee 50 is moved in the direction of the arrow 51 to perform squeegeeing.

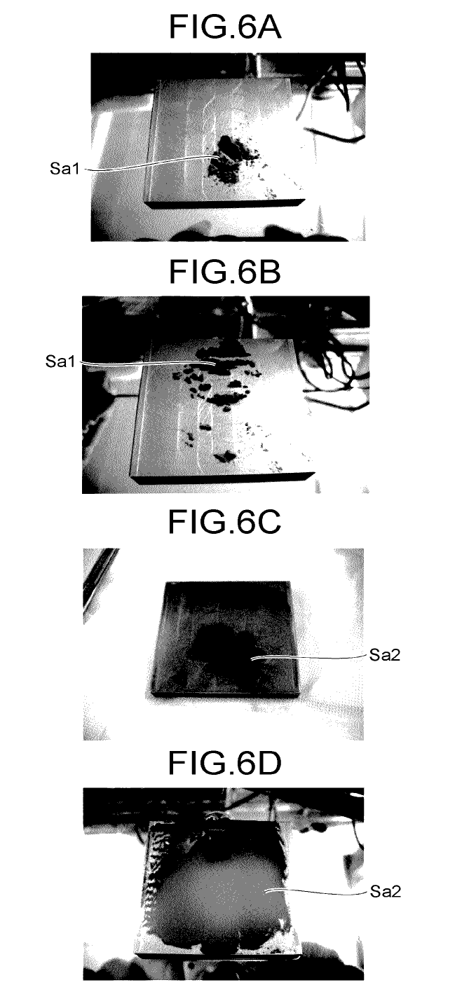

FIGS. 6(a) to 6(d) are each an illustrative pattern diagram of a property of slurry.

In the experiment, two samples (a sample Sa1 and a sample Sa2) are planarized with the squeegee 50 using the device 150 illustrated in FIG. 5. FIGS. 6(a) to 6(d) illustrate the states of a layer before and after squeegeeing. In these samples, a powder raw material having an average particle size equal to or smaller than 16 μm is used. The sample Sa1 is powder and not slurry. The sample Sa2 is slurry as a mixture of powder and an ethanol solution. The powder in the slurry has a volume concentration of 10% to 15%.

FIGS. 6(a) and 6(b) correspond to the sample Sa1 and schematically illustrate the states of the sample Sa1 before and after squeegeeing. FIGS. 6(c) and 6(d) correspond to the sample Sa2 and schematically illustrate the states of the sample Sa2 before and after squeegeeing.

FIG. 6(b) clearly indicates that the sample Sa1, which is powder having a small average particle size, causes a significant aggregation after squeegeeing. In contrast, FIG. 6(d) clearly indicates that the sample Sa2, which is slurry including powder, achieves a reduced aggregation after squeegeeing and thus prevents inadequate squeegeeing.

According to the embodiments, a highly productive method of manufacturing a layered object, a device for manufacturing the layered object, and slurry can be provided.

The embodiments of the present invention have been described above with reference to the specific examples. However, the present invention is not limited to these specific examples. For example, specific configurations of elements such as the slurry used in the manufacturing method, and the stage, the layer supplying unit, and the energy beam irradiation unit included in the manufacturing device are included in the scope of the present invention as long as the skilled person in the art can embody the present invention in the same or similar manner with the same or similar advantageous effects by making appropriate selections from the well-known range.

In addition, any technologically feasible combination of any two or more of elements in each specific example is included in the scope of the present invention as long as the combination contains the gist of the present invention.

Moreover, any method of manufacturing a layered object, any device for manufacturing the layered object, and any slurry that can be achieved by the skilled person in the art through design change as appropriate based on the method of manufacturing a layered object, the device for manufacturing the layered object, and the slurry described above as the embodiments of the present invention, and that contain the gist of the present invention, belong to the scope of the present invention as long as they contains the gist of the present invention.

It is understood that various modifications and corrections that would be thought of by the skilled person in the art in the category of the concept of the present invention belong to the scope of the present invention.

The above-described embodiments of the present invention have been presented as examples and are not intended to limit the scope of the invention. These novel embodiments may be achieved in other various modes, and various kinds of omissions, replacements, and changes are possible without departing from the gist of the invention. These embodiments and their modifications are included in the scope and gist of the invention and included in the invention recited in the claims and their equivalents.

1. A method of manufacturing a layered object, the method comprising:
a first process of supplying, onto a stage, a first slurry layer that includes a powder having a volume concentration of not smaller than 10% and not larger than 15% and a solvent;
a second process of irradiating a part of the first slurry layer with an energy beam to form a part of the layered object;
a third process of supplying a second slurry layer onto the part of the layered object; and
a fourth process of irradiating a part of the second slurry layer with an energy beam to form another part of the layered object, wherein
the third process and the fourth process are repeated more than once.

2. The method of manufacturing a layered object according to claim 1, further comprising:
a fifth process performed between the third process and the fourth process, wherein
the fifth process includes planarizing the second slurry layer.

3. The method of manufacturing a layered object according to claim 1, further comprising:
a sixth process performed between the third process and the fourth process, wherein
the sixth process includes drying the second slurry layer.

4. The method of manufacturing a layered object according to claim 1, wherein
the first process includes applying slurry onto the stage, and
the third process includes applying slurry onto the part of the layered object.

5. The method of manufacturing a layered object according to claim 4, wherein
the applying includes performing any one of a dispenser method, an inkjet method, a slit coating method, and a spin coating method.

6. A method of manufacturing a layered object, the method comprising:
a first process of disposing a first slurry film onto the stage;
a second process of irradiating a part of the first slurry film with an energy beam to form a part of the layered object,
a third process of disposing a second slurry film onto the part of the layered object, and
a fourth process of irradiating a part of the second slurry film with an energy beam to form another part of the layered object.

7-9. (canceled)

10. Slurry comprising:
powder as a material of a layered object; and
a solvent including at least one selected from the group consisting of alcohols, ethers, and ketones, wherein
the powder has a volume concentration of not smaller than 10% and not larger than 15%.

11. The slurry according to claim 10, further comprising at least one of a thickening agent, a reducing agent, and a rust preventive agent.

12. The slurry according to claim 10, wherein
the slurry is applied by an inkjet method, and
the slurry has a viscosity of not smaller than 1 cp and not larger than 200 cp.

13. The slurry according to claim 10, wherein
the slurry is applied by a slit coating method, and
the slurry has a viscosity of not smaller than 1 cp and not larger than 50,000 cp.

14. The slurry according to claim 10, wherein
the slurry is applied by a spin coating method, and
the slurry has a viscosity of not smaller than 1 cp and not larger than 300 cp.

15. The method of manufacturing a layered object according to claim 6, further comprising:
a process of forming a slurry layer with a slurry including a powder before the first process; and
a process of drying the slurry layer to form the first slurry film.

16. The method of manufacturing a layered object according to claim 6, further comprising:
a process of drying the first slurry film before the second process.
